(19) United States
(12) Patent Application Publication
(10) Pub. No.: US 2018/0270243 A1
(43) Pub. Date: Sep. 20, 2018

(54) PREVENTING WIDESPREAD TAKEOVER OF ACCOUNTS

(71) Applicant: International Business Machines Corporation, Armonk, NY (US)

(72) Inventors: Christopher J. Hardee, Raleigh, NC (US); Steven R. Joroff, River Vale, NJ (US); Pamela A. Nesbitt, Raleigh, NC (US); Scott E. Schneider, Rolesville, NC (US)

(21) Appl. No.: 15/462,044

(22) Filed: Mar. 17, 2017

(51) Int. Cl. H04L 29/06

(52) U.S. Cl. CPC H04L 63/102; H04L 63/0815; H04L 63/083

(57) ABSTRACT

Embodiments of the invention include a method for determining that a change has occurred to a first account. The first account is a linked account that is linked with at least one second account in a single sign-on environment. The method can also include determining that the change to the first account meets a condition for performing a response action. The method can also include performing the response action if the change meets the condition. The response action prevents changes to the at least one second account.

### BACKGROUND

The present invention relates in general to accessing computing systems through websites. More specifically, the present invention relates to preventing widespread takeover of accounts that are configured within a single sign-on computing environment.

A user that has a first registered account with a first website and/or a first application can be allowed by the first website/application to link the first registered account with a second registered account of a second website/application. Linking the first registered account with the second registered account allows the user to access each of the first and second websites/applications by signing into one account without requiring separate verification of the user's identity at each website/application. A user account of a website/application that is linked to another account of another website/application can generally be referred to as a “linked account.”

### SUMMARY

A method according to one or more embodiments of the present invention includes determining that a change has occurred to a first account. The first account is a linked account that is linked with at least one second account in a single sign-on environment. A determination is made that the change to the first account meets a condition for performing a response action. The response action is performed if the change meets the condition. The response action prevents changes to the at least one second account.

According to one or more embodiments of the present invention, a computer system includes a memory. The computer system also includes a processor system communicatively coupled to the memory. The processor system is configured to perform a method including determining that a change has occurred to a first account. The first account is a linked account that is linked with at least one second account in a single sign-on environment. A determination is made that the change to the first account meets a condition for performing a response action. The response action is performed if the change meets the condition. The response action prevents changes to the at least one second account.

According to one or more embodiments of the present invention, a computer program product including a computer-readable storage medium is provided. The computer-readable storage medium has program instructions embodied therewith. The computer-readable storage medium is not a transitory signal per se, the program instructions readable by a processor system to cause the processor system to perform a method. The method includes determining that a change has occurred to a first account. The first account is a linked account that is linked with at least one second account in a single sign-on environment. A determination is made that the change to the first account meets a condition for performing a response action. The response action is performed if the change meets the condition. The response action prevents changes to the at least one second account.

### BRIEF DESCRIPTION OF THE DRAWINGS

The subject matter of the present invention is particularly pointed out and distinctly defined in the claims at the conclusion of the specification. The foregoing and other features and advantages are apparent from the following detailed description taken in conjunction with the accompanying drawings in which:

FIG. 1 depicts a flowchart of a method, in accordance with one or more embodiments of the present invention;

FIG. 2 depicts a high-level block diagram of a computer system, which can be used to implement one or more embodiments; and

FIG. 3 depicts a computer program product, in accordance with an embodiment of the present invention.

### DETAILED DESCRIPTION

In accordance with one or more embodiments of the invention, methods and computer program products for preventing widespread takeover of accounts are provided. Various embodiments of the present invention are described herein with reference to the related drawings. Alternative embodiments can be devised without departing from the scope of this invention. References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Additionally, although this disclosure includes a detailed description of a computing device configuration, implementation of the teachings recited herein are not limited to a particular type or configuration of computing device(s). Rather, embodiments of the present disclosure are capable of being implemented in conjunction with any other type or configuration of wireless or non-wireless computing devices and/or computing environments, now known or later developed.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

For the sake of brevity, conventional techniques related to computer processing systems and computing models may or may not be described in detail herein. Moreover, it is understood that the various tasks and process steps described herein can be incorporated into a more comprehensive procedure, process or system having additional steps or functionality not described in detail herein.

Linked accounts allow a user to access each website/application (corresponding to each of the user's linked accounts) without separately verifying the user's identity at each website/application. In other words, if the user verifies the user's identity by logging/signing into one of the linked accounts, the user can access the website/application of the user's other linked accounts without performing a separate verification of the user's identity for each website/application. A plurality of websites/applications that allow access via single-user verification can be generally referred to as a “single sign-on” environment.

Linked accounts can reduce the number of accounts that the users need to manage, reduce the number of passwords that the users need to retain, and enable integration between different systems of the websites/applications. However, the use of linked accounts within a single sign-on environment can be problematic if the security of one or more linked accounts is compromised. For example, if an unauthorized intruder gains access to one linked account of a user, the unauthorized intruder can also gain access to the other accounts of the user.

In view of the difficulties described above, one or more embodiments use a single sign-on authority to receive and disseminate information regarding account changes. The received and disseminated information allows a user to prevent widespread unauthorized access across the user's linked accounts.

Once a user registers/creates an account that can be linked to other accounts in a single sign-on environment, the user can define and/or select conditions that trigger response actions. In other words, if certain defined or selected conditions are determined to be met, a response action is triggered. The triggered response actions govern changes across the linked accounts. A central authority entity can determine whether or not the defined/selected conditions have been met, and the central authority can perform, for example, a triggered response action, which is described in more detail below.

Each of the websites/applications that are associated with the linked accounts can report account changes to the central authority entity. Once accounts are linked together within a single sign-on environment, changes that are made in any of the linked accounts can be reported to the central authority entity. For example, if a change occurs in one of the linked accounts, the application/website (corresponding to the changed account) can report the characteristics of the change to the central authority.

Based on the reported account change, the central authority can then determine whether or not the reported account change meets the defined/selected conditions for triggering a response action. The conditions can correspond to changes that an unauthorized intruder is likely to perform. For example, the conditions for triggering a response action can be met if at least one of the following changes has occurred: (1) a deletion of an account has occurred, (2) a change of contact information of at least one account has occurred, (3) a change in a primary password of at least one account has occurred, (4) a change in a secondary password of at least one account has occurred, (5) a change in identifying information has occurred, (6) a change in device that has been used to access the account has occurred, (7) a change in internet protocol address that has been used to access the account has occurred, (8) a change in a geographical location that has been used to access the account has occurred, (9) a removal of a requirement to perform dual-factor authentication has occurred, and/or (10) a change in account activity from the normal activity has occurred. A change in activity (from the normal activity) can include any activity that is atypical of the user, such as excessive spending, and/or activity that occurs during a time of day that is not typical of the user, for example.

Further, one or more embodiments can configure the central authority entity to consider the conditions for triggering a response action as being met, if a combination of the above-described changes has occurred. For example, each of the above-described changes can be assigned a point value, and the central authority entity can consider the conditions for triggering a response as being met if the cumulative point value (of the changes which have occurred) meets or exceeds a threshold point value.

If a defined/selected condition for triggering a response action is met, then the response action is performed. Response actions include, but are not limited to, the following: (1) informing the user using contact information that is stored by the central authority entity, (2) setting a period of time, where one or more accounts are not permitted to perform certain types of changes during the period of time, and/or (3) requesting that the other accounts (that are linked to the changed account) prevent user access, until the user provides verification/authentication to the central authority entity via a different form of authentication than the authentication that was used to effect the change. By contacting the user using contact information that is stored by the central authority, embodiments of the present invention can possibly avoid using contact information that has already been compromised by an unauthorized intruder.

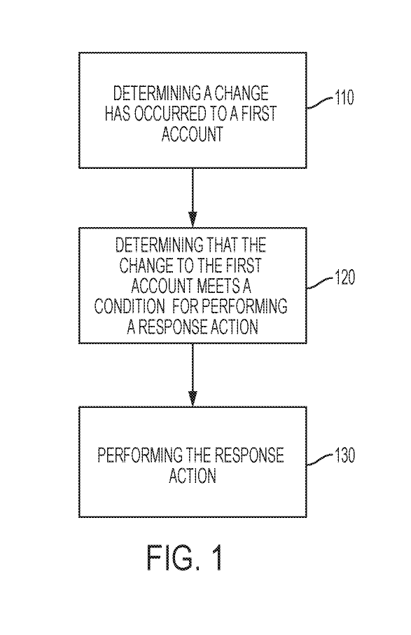

FIG. 1 depicts a flowchart of a method in accordance with one or more embodiments of the present invention. The method includes, at 110, determining a change has occurred to a first account. The first account is a linked account that is linked together with at least one second account in a single sign-on environment. As described above, once the first account and the at least one second account are linked within a single sign-on environment, changes that are made in any of the accounts can be reported to a central authority entity, for example. The method also includes, at 120, determining that the change to the first account meets a condition for performing a response action. As described above, example conditions for performing a response action can be met if at least one of the following changes has occurred: (1) a deletion of the first account has occurred, (2) a change of contact information of the first account has occurred, (3) a change in a primary password of the first account has occurred, (4) a change in a secondary password of the first account has occurred, (5) a change in identifying information has occurred, (6) a change in device that has been used to access the first account has occurred, (7) a change in internet protocol address that has been used to access the first account has occurred, (8) a change in a geographical location that has been used to access the first account has occurred, (9) a removal of a requirement to perform dual-factor authentication has occurred, and/or (10) a change in account activity from the normal activity has occurred. The method also includes, at 130, performing the response action if the change meets the condition. The response action prevents changes to the at least one second account.

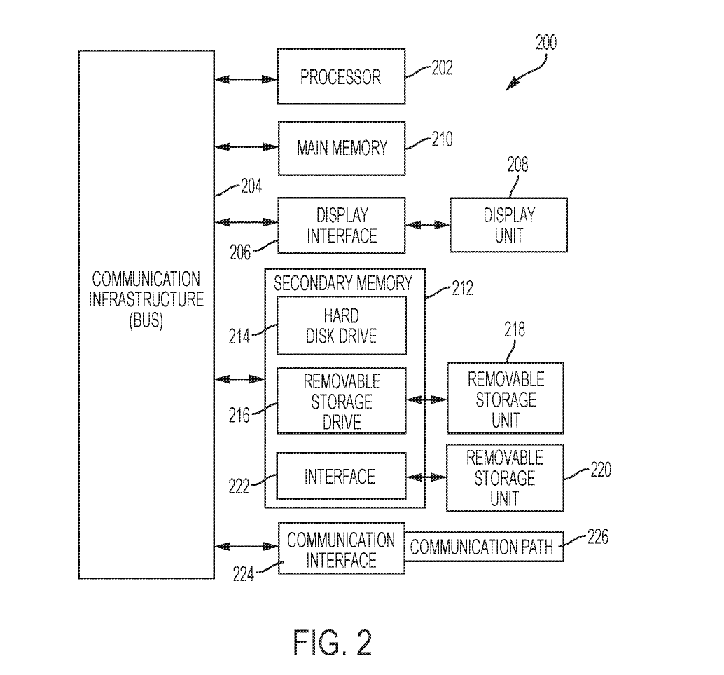

FIG. 2 depicts a high-level block diagram of a computer system 200, which can be used to implement one or more embodiments. Computer system 200 can correspond to, at least, a central authentication server, an application server, a web server, and/or a network server, for example. Computer system 200 can be used to implement hardware components of systems capable of performing methods described herein. Although one exemplary computer system 200 is shown, computer system 200 includes a communication path 226, which connects computer system 200 to additional systems (not depicted) and can include one or more wide area networks (WANs) and/or local area networks (LANs) such as the Internet, intranet(s), and/or wireless communication network(s). Computer system 200 and additional system are in communication via communication path 226, e.g., to communicate data between them.

Computer system 200 includes one or more processors, such as processor 202. Processor 202 is connected to a communication infrastructure 204 (e.g., a communications bus, cross-over bar, or network). Computer system 200 can include a display interface 206 that forwards graphics, textual content, and other data from communication infrastructure 204 (or from a frame buffer not shown) for display on a display unit 208. Computer system 200 also includes a main memory 210, preferably random access memory (RAM), and can also include a secondary memory 212.

Secondary memory 212 can include, for example, a hard disk drive 214 and/or a removable storage drive 216, representing, for example, a floppy disk drive, a magnetic tape drive, or an optical disc drive. Hard disk drive 214 can be in the form of a solid state drive (SSD), a traditional magnetic disk drive, or a hybrid of the two. There also can be more than one hard disk drive 214 contained within secondary memory 212. Removable storage drive 216 reads from and/or writes to a removable storage unit 218 in a manner well known to those having ordinary skill in the art. Removable storage unit 218 represents, for example, a floppy disk, a compact disc, a magnetic tape, or an optical disc, etc. which is read by and written to by removable storage drive 216. As will be appreciated, removable storage unit 218 includes a computer-readable medium having stored therein computer software and/or data.

In alternative embodiments, secondary memory 212 can include other similar means for allowing computer programs or other instructions to be loaded into the computer system. Such means can include, for example, a removable storage unit 220 and an interface 222. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 220 and interfaces 222 which allow software and data to be transferred from the removable storage unit 220 to computer system 200.

Computer system 200 can also include a communications interface 224. Communications interface 224 allows software and data to be transferred between the computer system and external devices. Examples of communications interface 224 can include a modem, a network interface (such as an Ethernet card), a communications port, or a PC card slot and card, a universal serial bus port (USB), and the like. Software and data transferred via communications interface 224 are in the form of signals that can be, for example, electronic, electromagnetic, optical, or other signals capable of being received by communications interface 224. These signals are provided to communications interface 224 via communication path (i.e., channel) 226. Communication path 226 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 210 and secondary memory 212, removable storage drive 216, and a hard disk installed in hard disk drive 214. Computer programs (also called computer control logic) are stored in main memory 210 and/or secondary memory 212. Computer programs also can be received via communications interface 224. Such computer programs, when run, enable the computer system to perform the features discussed herein. In particular, the computer programs, when run, enable processor 202 to perform the features of the computer system. Accordingly, such computer programs represent controllers of the computer system. Thus it can be seen from the forgoing detailed description that one or more embodiments provide technical benefits and advantages.

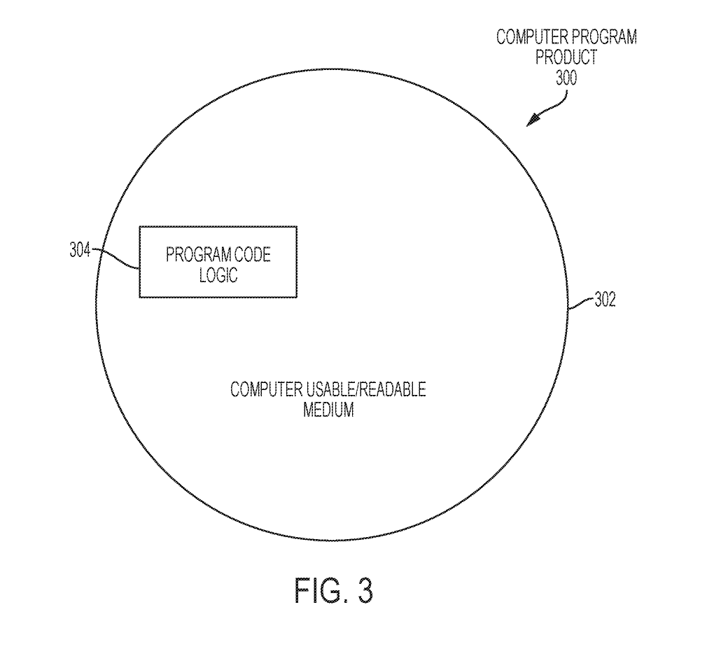

FIG. 3 depicts a computer program product 300, in accordance with an embodiment of the present invention. Computer program product 300 includes a computer-readable storage medium 302 and program instructions 304.

Embodiments can be a system, a method, and/or a computer program product. The computer program product can include a computer-readable storage medium (or media) having computer-readable program instructions thereon for causing a processor to carry out aspects of embodiments of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform embodiments of the present invention.

Aspects of various embodiments are described herein with reference to flowchart illustrations and/or block diagrams of methods, apparatus (systems), and computer program products according to various embodiments. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments described herein.

What is claimed is:

1. A computer implemented method comprising:
determining, using a processor system, that a change has occurred to a first account, wherein the first account is a linked account that is linked with at least one second account in a single sign-on environment;
determining, using the processor system, that the change to the first account meets a condition for performing a response action; and
performing the response action if the change meets the condition, wherein the response action prevents changes to the at least one second account.

2. The computer implemented method of claim 1, wherein the condition for performing the response action comprises at least one of:
deletion of the first account,
a change of contact information of the first account,
a change in a secondary password of the first account,
a removal of a requirement to perform dual-factor authentication, and
an abnormal account activity.

3. The computer implemented method of claim 1, wherein the determining the change has occurred to the first account comprises determining by a central authority entity.

4. The computer implemented method of claim 3, wherein performing the response action comprises performing at least one of:
informing a user of the first account that the first account has been changed, wherein the user is informed via contact information that is stored by the central authority entity,
setting a period of time during which changes to the at least one second account is not permitted, and
requesting that access to the at least one second account be locked.

5. The computer implemented method of claim 1, wherein the first account comprises a registered account for a website or a computing application.

6. The computer implemented method of claim 1, wherein the first account is linked together with the at least one second account such that, if a user logs into the first account, then the user can access the at least one second account without performing a separate verification.

7. The computer implemented method of claim 1, wherein determining the change has occurred to the first account comprises receiving characteristics of the change.

8. A computer system comprising:
a memory; and
a processor system communicatively coupled to the memory;
the processor system configured to perform a method comprising:
determining that a change has occurred to a first account, wherein the first account is a linked account that is linked with at least one second account in a single sign-on environment;
determining that the change to the first account meets a condition for performing a response action; and
performing the response action if the change meets the condition, wherein the response action prevents changes to the at least one second account.

9. The computer system of claim 8, wherein the condition for performing the response action comprises at least one of:
deletion of the first account,
a change of contact information of the first account,
a change in a secondary password of the first account,
a removal of a requirement to perform dual-factor authentication, and
an abnormal account activity.

10. The computer system of claim 8, wherein the determining the change has occurred to the first account comprises determining by a central authority entity.

11. The computer system of claim 10, wherein performing the response action comprises performing at least one of:
informing a user of the first account that the first account has been changed, wherein the user is informed via contact information that is stored by the central authority entity,
setting a period of time during which changes to the at least one second account is not permitted, and
requesting that access to the at least one second account be locked.

12. The computer system of claim 8, wherein the first account comprises a registered account for a website or a computing application.

13. The computer system of claim 8, wherein the first account is linked together with the at least one second account such that, if a user logs into the first account, then the user can access the at least one second account without performing a separate verification.

14. The computer system of claim 8, wherein determining the change has occurred to the first account comprises receiving characteristics of the change.

15. A computer program product for preventing widespread takeover of accounts, the computer program product comprising a computer readable storage medium having program instructions embodied therewith, the program instructions readable by a processor system to cause the processor system to:
determine, by the processor system, that a change has occurred to a first account, wherein the first account is a linked account that is linked with at least one second account in a single sign-on environment;
determine, by the processor system, that the change to the first account meets a condition for performing a response action; and
perform, by the processor system, the response action if the change meets the condition, wherein the response action prevents changes to the at least one second account.

16. The computer program product of claim 15, wherein the condition for performing the response action comprises at least one of:
deletion of the first account,
a change of contact information of the first account,
a change in a secondary password of the first account,
a removal of a requirement to perform dual-factor authentication, and
an abnormal account activity.

17. The computer program product of claim 15, wherein the determining the change has occurred to the first account comprises determining by a central authority entity.

18. The computer program product of claim 17, wherein performing the response action comprises performing at least one of:
informing a user of the first account that the first account has been changed, wherein the user is informed via contact information that is stored by the central authority entity,
setting a period of time during which changes to the at least one second account is not permitted, and
requesting that access to the at least one second account be locked.

19. The computer program product of claim 15, wherein the first account comprises a registered account for a website or a computing application.

20. The computer program product of claim 15, wherein the first account is linked together with the at least one second account such that, if a user logs into the first account, then the user can access the at least one second account without performing a separate verification.
